(19) United States
(12) Patent Application Publication
(10) Pub. No.: US 2026/0094772 A1
(43) Pub. Date: Apr. 2, 2026

(54) CONTACTOR

(71) Applicants: Tyco Electronics (Shanghai) Co., Ltd., Shanghai (CN); Tyco Electronics Technology (SIP) Co., Ltd., Suzhou (CN)

(72) Inventors: Kevin (Xujia) Wang, Suzhou (CN); Zesheng Jiang, Suzhou (CN); Quarry (Bingfeng) Qu, Suzhou (CN); Yisong Wu, Shanghai (CN); Wenpei Qin, Suzhou (CN); Lizhong Wang, Shanghai (CN); Xingzhuo (Michael) Li, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/343,596

(22) Filed: Sep. 29, 2025

(30) Foreign Application Priority Data
Sep. 29, 2024 (CN) 202411375783.1

(51) Int. Cl. H01H 1/24; H01H 9/30; H01H 13/04; H01H 13/20

(52) U.S. Cl. CPC H01H 1/242; H01H 9/30; H01H 13/04; H01H 13/20

(57) ABSTRACT

A contactor includes an upper insulation shell, a pair of static contacts, a movable contact, a driving assembly, an insulation bracket and a microswitch. The upper insulation shell has an arc extinguishing chamber. The pair of static contacts are fixed to the upper insulation shell. The movable contact is arranged in the arc extinguishing chamber and is movable between a closed position and an open position. The driving assembly is arranged in the arc extinguishing chamber, and drives the movable contact to move between the closed position and the open position. The insulation bracket is installed into the arc extinguishing chamber and is formed with a receiving chamber separated from the arc extinguishing chamber. The microswitch is installed in the receiving chamber of the insulation bracket. The driving assembly has a pressing part for pressing the microswitch when the movable contact is moved to the closed position.

### CROSS-REFERENCE TO RELATED APPLICATION

This application claims the benefit of Chinese Patent Application No. CN202411375783.1 filed on Sep. 29, 2024, in the State Intellectual Property Office of China, the whole disclosure of which is incorporated herein by reference.

### FIELD OF THE DISCLOSURE

The disclosure relates to a contactor, and particularly to an air type high-voltage direct current contactor.

### BACKGROUND OF THE INVENTION

In the prior art, the design of high-voltage DC auxiliary contact structure often adopts reed or reed switch type. The advantage of the reed type high-voltage DC auxiliary contact structure is that the reed stroke can be customized according to the contactor stroke. The disadvantage is that it has high requirements for the material and structure of the spring, and the contacts are exposed to the arc extinguishing chamber, which is prone to contamination. In addition, the auxiliary signal is transferred to the external connector of the product through adapter terminals and two soldering joints. This results in the static contact needing to be brazed onto the ceramic, connected to the external connector through welding and adapter terminals, with complex assembly processes and relatively high costs.

In the prior art, the advantage of the reed switch type high-voltage DC auxiliary contact structure is that it can achieve signal control under non-contact conditions, and the auxiliary contacts are sealed. The disadvantages of the reed switch type high-voltage DC auxiliary contact structure are complex assembly, high installation accuracy, susceptibility to external strong magnetic interference, and poor impact resistance of the contacts. In addition, welding wires on the reed switch, which are led out from the housing through a protective sleeve, makes it difficult to achieve automation, has high assembly costs, and is inconvenient to use.

### SUMMARY OF THE INVENTION

According to an embodiment of the present disclosure, a contactor includes an upper insulation shell, a pair of static contacts, a movable contact, a driving assembly, an insulation bracket and a microswitch. The upper insulation shell has an arc extinguishing chamber. The pair of static contacts are fixed to the upper insulation shell. The movable contact is arranged in the arc extinguishing chamber and is movable between a closed position and an open position. The driving assembly is arranged in the arc extinguishing chamber, and drives the movable contact to move between the closed position and the open position. The insulation bracket is installed into the arc extinguishing chamber and is formed with a receiving chamber separated from the arc extinguishing chamber. The microswitch is installed in the receiving chamber of the insulation bracket. The driving assembly has a pressing part for pressing the microswitch when the movable contact is moved to the closed position.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of the upper half of a contactor according to an exemplary embodiment of the present invention;

FIG. 2 shows an illustrative exploded view of the upper half of a contactor according to an exemplary embodiment of the present invention;

FIG. 3 shows an assembled sectional view of the upper half of a contactor according to an exemplary embodiment of the present invention;

FIG. 4 shows an exploded sectional view of the upper half of a contactor according to an exemplary embodiment of the present invention;

FIG. 5 shows an illustrative perspective view of the insulation bracket and microswitch of a contactor according to an exemplary embodiment of the present invention;

FIG. 6 shows an illustrative perspective view of a microswitch and adapter terminal of a contactor according to an exemplary embodiment of the present invention;

FIG. 7 shows an illustrative exploded view of the microswitch and adapter terminal of a contactor according to an exemplary embodiment of the present invention;

FIG. 8 shows an illustrative perspective view of a microswitch and coil assembly of a contactor according to an exemplary embodiment of the present invention;

FIG. 9 shows an illustrative perspective view of a microswitch, coil, adapter terminal, first lead terminal, and second lead terminal of a contactor according to an exemplary embodiment of the present invention;

FIG. 10 shows an assembly schematic diagram of a microswitch and coil assembly of a contactor according to another exemplary embodiment of the present invention;

FIG. 11 shows an illustrative perspective view of a microswitch, adapter terminal, first lead terminal, and second lead terminal of a contactor according to another exemplary embodiment of the present invention; and

FIG. 12 shows an illustrative exploded view of the microswitch and coil assembly of a contactor according to another exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a contactor comprises an upper insulation shell which is formed with an arc extinguishing chamber; a pair of static contacts fixed to the upper insulation shell and extending into the arc extinguishing chamber; a movable contact which is arranged in the arc extinguishing chamber and can be moved between a closed position in electrical contact with the static contact and an open position in electrical separation from the static contact; a driving assembly, which is movable and arranged in the arc extinguishing chamber, is used to drive the movable contact to move between the closed position and the open position; an insulation bracket which is installed into the arc extinguishing chamber of the upper insulation shell and formed with a receiving chamber separated from the arc extinguishing chamber; and a microswitch which is installed in the receiving chamber of the insulation bracket. The driving assembly has a pressing part for pressing the microswitch, wherein the microswitch is pressed by the pressing part when the movable contact is moved to the closed position, and is not in contact with the pressing part when the movable contact is moved to the open position.

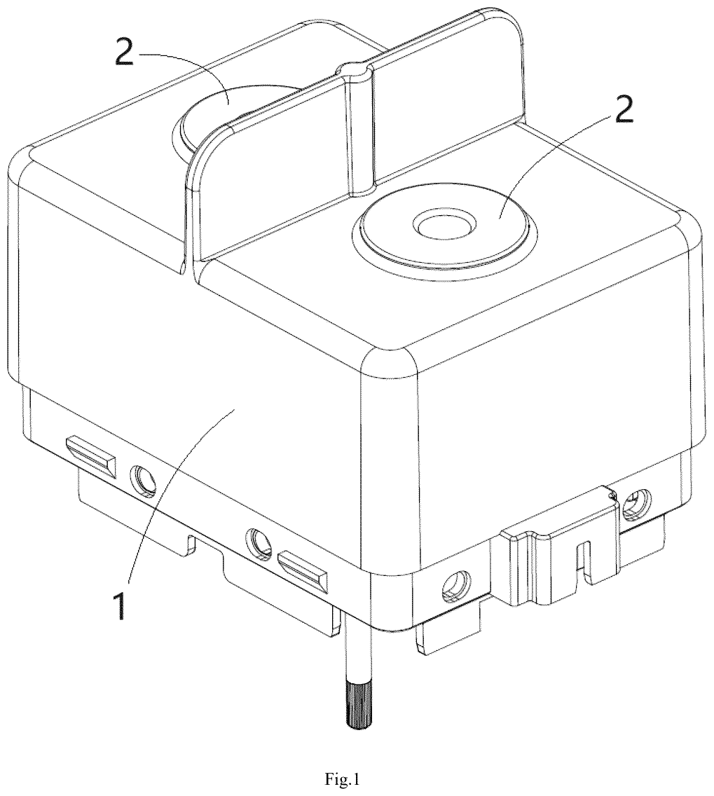

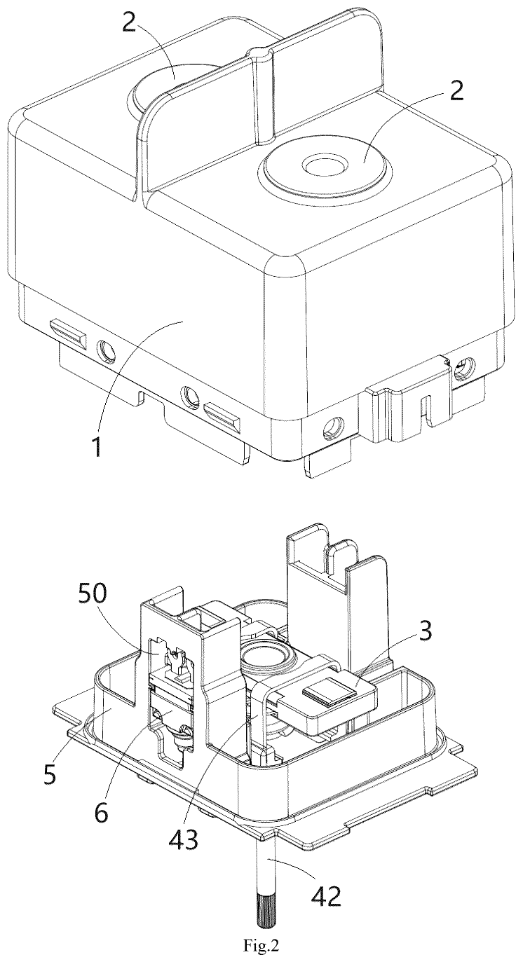

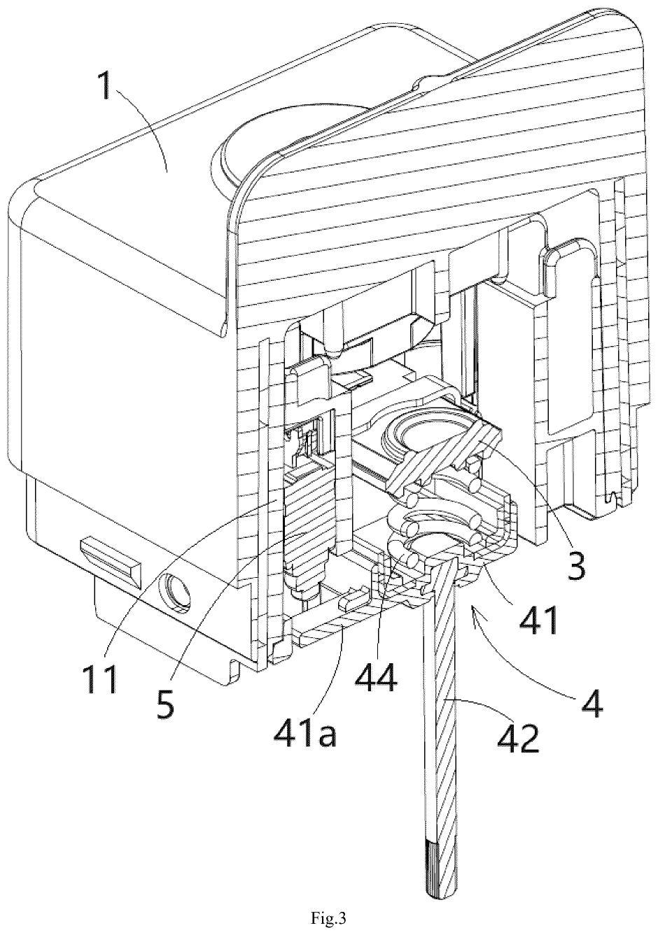

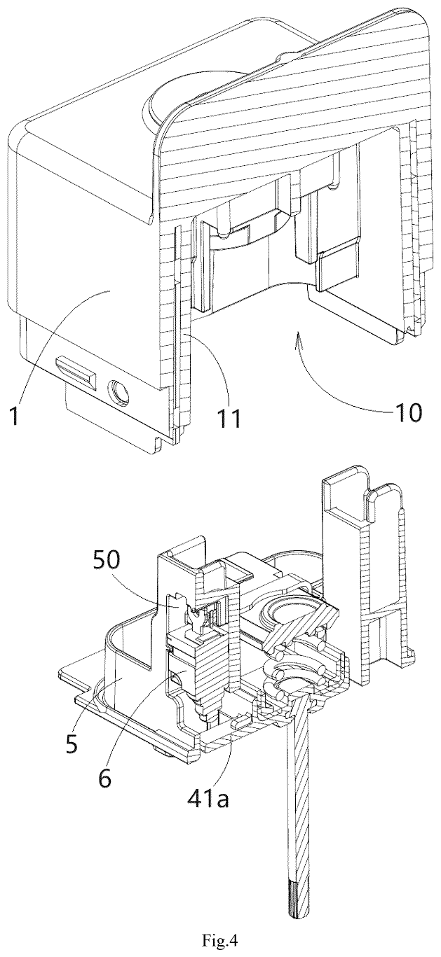

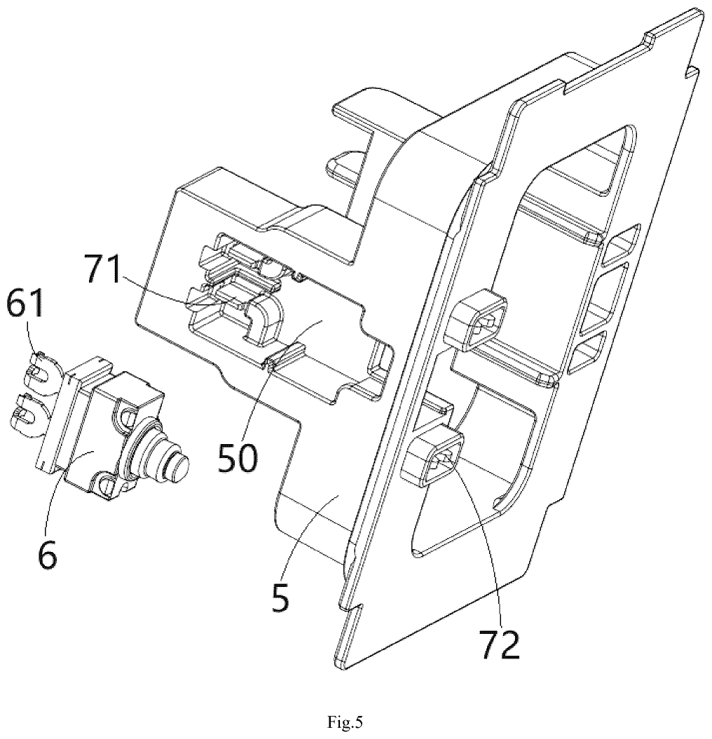

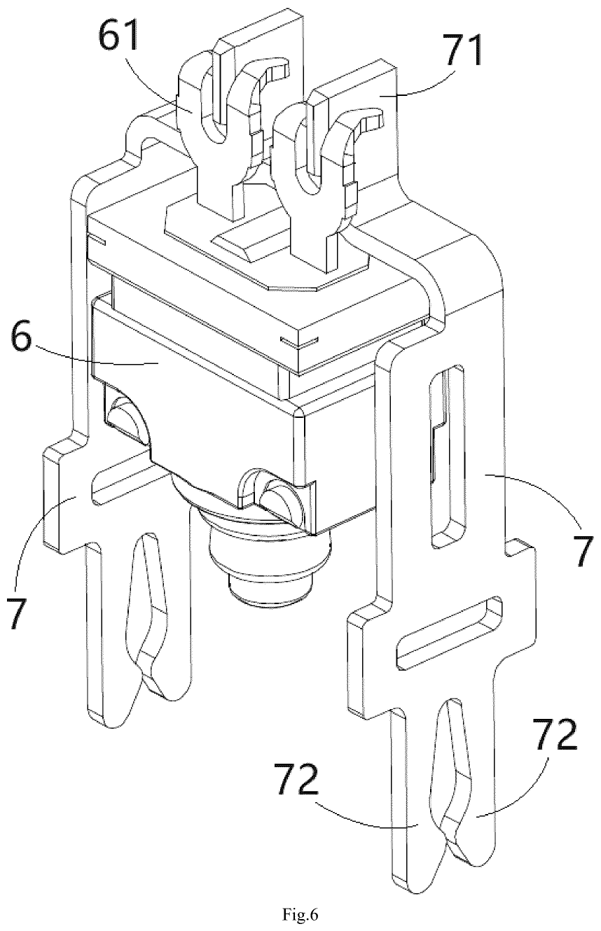

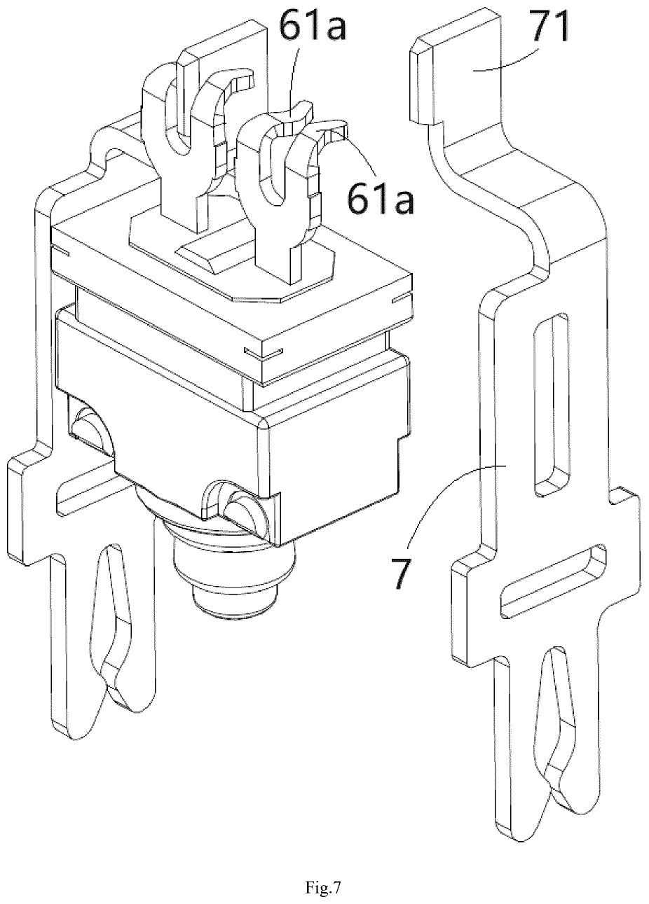

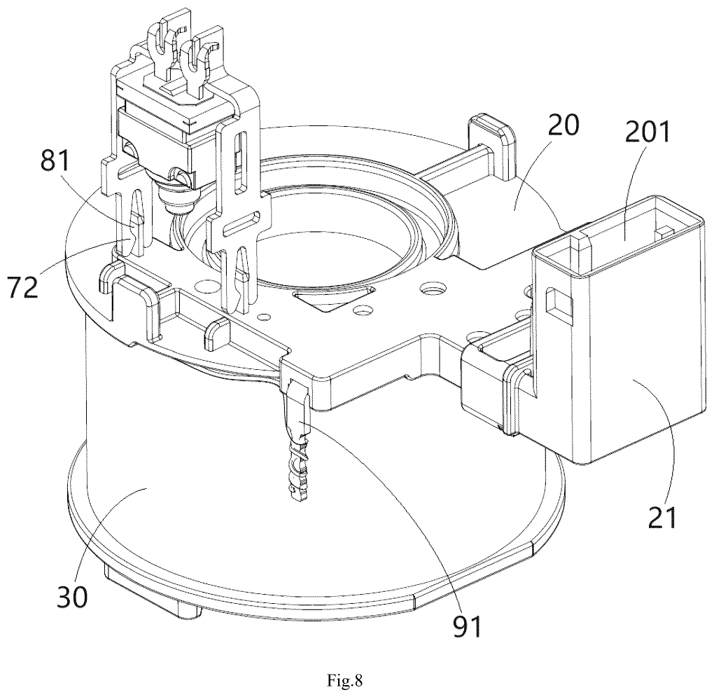

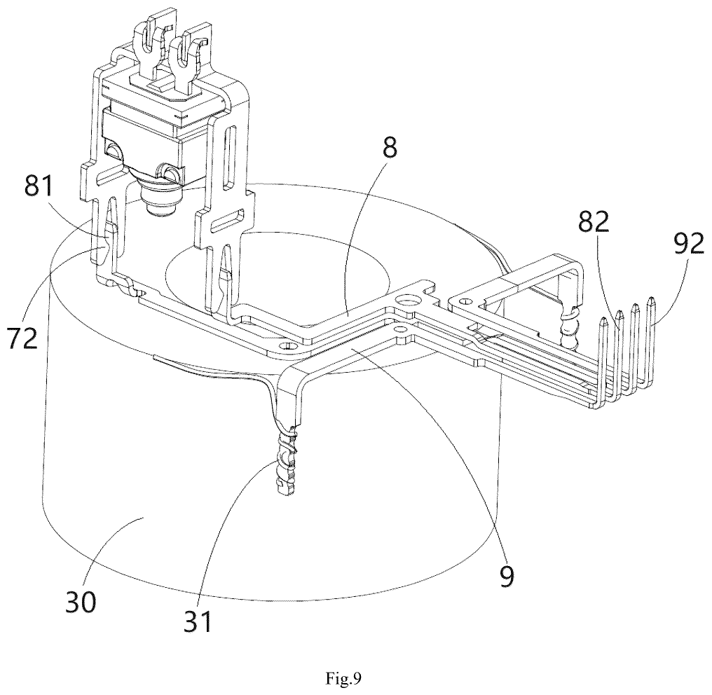

FIG. 1 shows an illustrative perspective view of the upper half of a contactor according to an exemplary embodiment of the present invention. FIG. 2 shows an illustrative exploded view of the upper half of a contactor according to an exemplary embodiment of the present invention. FIG. 3 shows an assembled sectional view of the upper half of a contactor according to an exemplary embodiment of the present invention. FIG. 4 shows an exploded sectional view of the upper half of a contactor according to an exemplary embodiment of the present invention. FIG. 5 shows an illustrative perspective view of the insulation bracket 5 and microswitch 6 of a contactor according to an exemplary embodiment of the present invention. FIG. 6 shows an illustrative perspective view of a microswitch 6 and an adapter terminal 7 of a contactor according to an exemplary embodiment of the present invention. FIG. 7 shows an illustrative exploded view of the microswitch 6 and adapter terminal 7 of a contactor according to an exemplary embodiment of the present invention. FIG. 8 shows an illustrative perspective view of the microswitch 6 and coil assembly of a contactor according to an exemplary embodiment of the present invention. FIG. 9 shows an illustrative perspective view of the microswitch 6, coil 30, adapter terminal 7, first lead terminal 8, and second lead terminal 9 of a contactor according to an exemplary embodiment of the present invention.

As shown in FIGS. 1-9, in an exemplary embodiment of the present disclosure, a contactor is disclosed. The contactor includes an upper insulation shell 1, a pair of static contacts 2, a movable contact 3, a driving assembly 4, an insulation bracket 5, and a microswitch 6. An arc extinguishing chamber 10 is formed in the upper insulation shell 1. The pair of static contacts 2 are fixed to the upper insulation shell 1 and extend into the arc extinguishing chamber 10. The movable contact 3 is set in the arc extinguishing chamber 10 and can be moved between a closed position in electrical contact with the static contact 2 and an open position in electrical separation from the static contact 2. The driving assembly 4 is movable in the arc extinguishing chamber 10, used to drive the movable contact 3 to move between the closed position and the open position. The insulation bracket 5 is installed into the arc extinguishing chamber 10 of the upper insulation shell 1 and formed with a receiving chamber 50 separated from the arc extinguishing chamber 10. Microswitch 6 is installed in the receiving chamber 50 of the insulation bracket 5. The driving assembly 4 has a pressing part 41a for pressing the microswitch 6. The microswitch 6 is pressed by the pressing part 41a when the movable contact 3 is moved to the closed position, and the microswitch 6 is not in contact with the pressing part 41a when the movable contact 3 is moved to the open position.

In an exemplary embodiment of the present invention, the microswitch 6 may be a normally open switch. When the microswitch 6 is pressed by the pressing part 41a, it switches from an open state to a closed state. In another exemplary embodiment of the present invention, the microswitch 6 may be a normally closed switch, and when the microswitch 6 is pressed by the pressing part 41a, it switches from a closed state to an open state.

The receiving chamber 50 of the insulation bracket 5 has an installation port facing the side wall 11 of the upper insulation shell 1. The microswitch 6 is installed into the receiving chamber 50 of the insulation bracket 5 through the installation port. The installation port of the receiving chamber 50 is covered by the side wall 11 of the upper insulation shell 1.

The contactor further comprises a pair of adapter terminals 7, which are arranged in the insulation bracket 5 and respectively electrically connected to the two connection terminals 61 of the microswitch 6. In the illustrated embodiment, the insulation bracket 5 is an injection molded part on the pair of adapter terminals 7, so that the insulation bracket 5 and the pair of adapter terminals 7 are integrated into one piece. The adapter terminal 7 has a first tongue 71 located at one end, and the connection terminal 61 of the microswitch 6 has a pair of first spring arms 61a, with the first tongue 71 inserted and clamped between the pair of first spring arms 61a.

As shown in FIGS. 1-9, in the illustrated embodiment, the contactor further includes a pair of first lead terminals 8, which are respectively electrically connected to the other ends of the pair of adapter terminals 7. The adapter terminal 7 has a pair of second spring arms 72 located at its other end, and the first lead terminal 8 has a second tongue 81 located at one end, which is inserted and clamped between the pair of second spring arms 72. In the illustrated embodiment, the first lead terminal 8 has a first pin 82 located at its other end, which is used for electrical connection to a connector (not shown).

The contactor further comprises: a lower insulation shell (not shown), a coil skeleton 20, a coil 30, and a pair of second lead terminals 9. The lower insulation shell is assembled with the upper insulation shell 1. The coil skeleton 20 is set in the lower insulation shell. Coil 30 is wound around coil skeleton 20. The pair of second lead terminals 9 are electrically connected to the two terminals 30a of the coil 30. The coil skeleton 20 is an injection molded part that is injected onto the pair of first lead terminals 8 and the pair of second lead terminals 9, making the coil skeleton 20, the pair of first lead terminals 8, and the pair of second lead terminals 9 an integrated piece.

The second lead terminal 9 has a second pin 92, and the coil skeleton 20 also has a mating part 21, in which a slot 201 is formed. The first pin 82 and the second pin 92 extend into the slot 201 to be electrically connected to the connector inserted into the slot 201.

The driving assembly 4 includes an insulation seat 41, a drive shaft 42, a limit bracket 43, and a spring 44. The drive shaft 42 is located below the insulation seat 41 and is fixed to the insulation seat 41. The limit bracket 43 is located above the insulation seat 41 and is fixed to the insulation seat 41. The spring 44 is installed in the limit bracket 43 and compressed axially between the movable contact 3 and the insulation seat 41. The pressing part 41a is formed on the insulation seat 41 and extends into the receiving chamber 50 of the insulation bracket 5. The insulation seat 41 is an injection molded part that is injected onto the bottom of the limit bracket 43 and the upper end of the drive shaft 42, making the insulation seat 41, limit bracket 43, and drive shaft 42 an integrated piece.

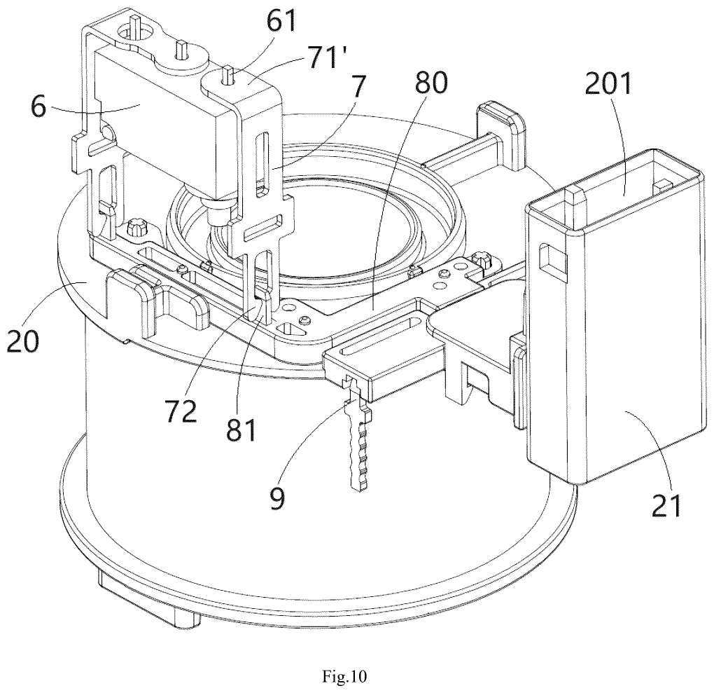

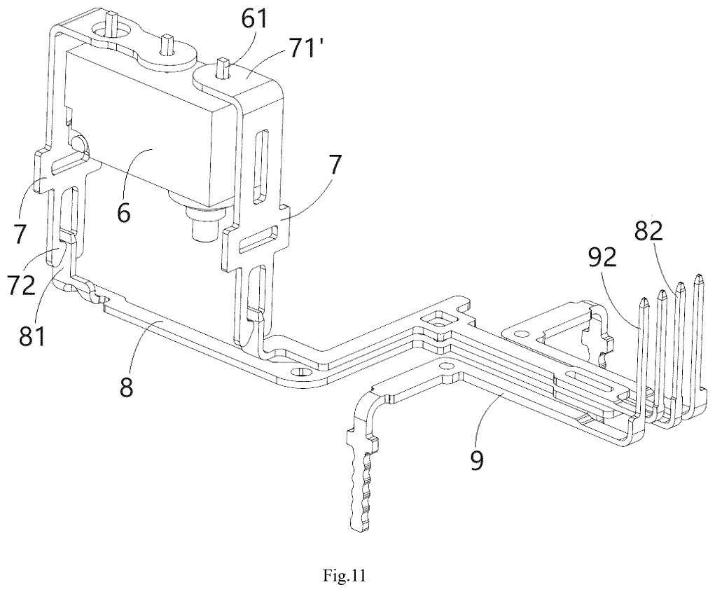

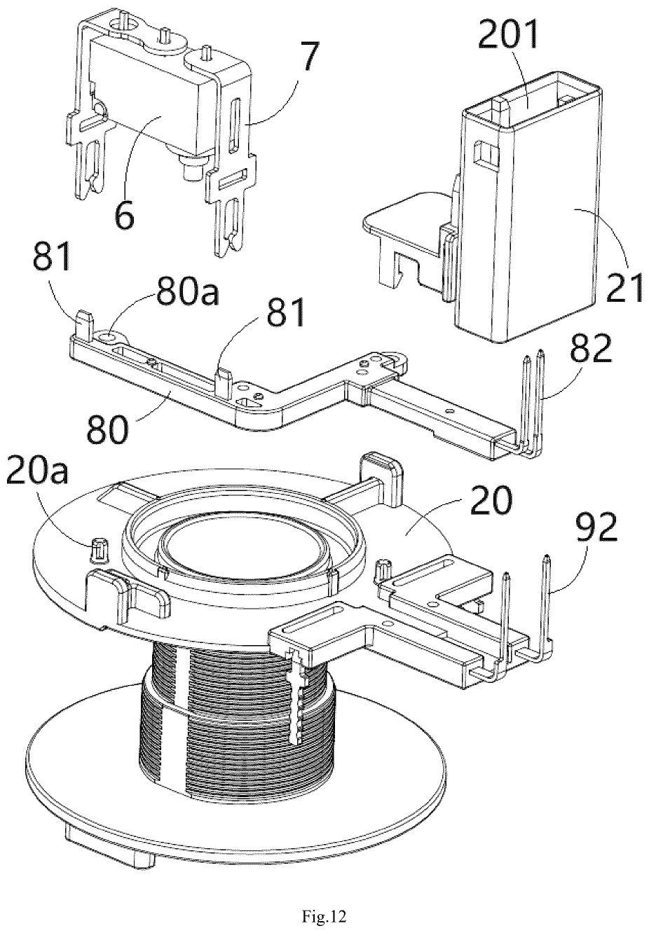

FIG. 10 shows an assembly schematic diagram of the microswitch 6 and coil assembly of a contactor according to another exemplary embodiment of the present invention. FIG. 11 shows an illustrative perspective view of a microswitch 6, an adapter terminal 7, a first lead terminal 8, and a second lead terminal 9 of a contactor according to another exemplary embodiment of the present invention. FIG. 12 shows an illustrative exploded view of the microswitch 6 and coil assembly of a contactor according to another exemplary embodiment of the present invention. The difference between the contactors shown in FIGS. 10-12 and those shown in FIGS. 1-9 lies in the structure of the connection terminal 61, adapter terminal 7, and coil assembly of the microswitch 6.

As shown in FIGS. 10-12, in the illustrated embodiment, the adapter terminal 7 has a soldering piece 71′ located at one end, and the connection terminal 61 of the microswitch 6 is needle shaped. The connection terminal 61 of the microswitch 6 passes through the soldering piece 71′ and is soldered to the soldering piece 71′.

The contactor further comprises: a lower insulation shell (not shown), a coil skeleton 20, a coil 30, a pair of second lead terminals 9, and a retaining body 80. The lower insulation shell is assembled with the upper insulation shell 1. The coil skeleton 20 is set in the lower insulation shell. Coil 30 is wound around coil skeleton 20. The pair of second lead terminals 9 are respectively electrically connected to the two terminals 30a of the coil 30. The retaining body 80 holds the pair of first lead terminals 8 and is detachably mounted on the coil skeleton 20. The retaining body 80 is an injection molded part onto the pair of first lead terminals 8, so that the retaining body 80 and the pair of first lead terminals 8 become an integrated piece. The coil skeleton 20 is an injection molded part onto the pair of second lead terminals 9, making the coil skeleton 20 and the pair of second lead terminals 9 an integrated piece.

A protruding post 20a is formed on the top of the coil skeleton 20, and an installation hole 80a is formed in the retaining body 80. The protruding post 20a is inserted into the installation hole 80a in an interference fit manner to fix the retaining body 80 on the top of the coil skeleton 20.

In the illustrated embodiment, the contactor further comprises a mating part 21, in which a slot 201 is formed. The mating part 21 is detachably assembled onto the coil skeleton 20. The second lead terminal 9 has a second pin 92, and the first pin 82 and the second pin 92 extend into the slot 201 of the mating part 21 to be electrically connected to the connector inserted into the slot 201.

Except for the aforementioned differences, the other technical features of the contactors shown in FIGS. 10-12 are the same or nearly the same as those of the contactors shown in FIGS. 1-9, which can be referred to as the contactors shown in FIGS. 1-9.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor, comprising:
an upper insulation shell formed with an arc extinguishing chamber;
a pair of static contacts fixed to the upper insulation shell and extending into the arc extinguishing chamber;
a movable contact arranged in the arc extinguishing chamber and movable between a closed position in electrical contact with the static contact and an open position in electrical separation from the static contact;
a movable driving assembly arranged in the arc extinguishing chamber and adapted to drive the movable contact to move between the closed position and the open position;
an insulation bracket installed into the arc extinguishing chamber of the upper insulation shell and formed with a receiving chamber separated from the arc extinguishing chamber; and
a microswitch installed in the receiving chamber of the insulation bracket, the driving assembly including a pressing part for pressing the microswitch, wherein the microswitch is pressed by the pressing part when the movable contact is moved to the closed position, and is not in contact with the pressing part when the movable contact is moved to the open position.

2. The contactor according to claim 1, wherein the microswitch is a normally open switch, and when the microswitch is pressed by the pressing part, the microswitch switches from an open state to a closed state.

3. The contactor according to claim 1, wherein the microswitch is a normally closed switch, and when the microswitch is pressed by the pressing part, the microswitch switches from a closed state to an open state.

4. The contactor according to claim 1, wherein the receiving chamber of the insulation bracket has an installation port facing the side wall of the upper insulation shell, and the microswitch is installed into the receiving chamber of the insulation bracket through the installation port, and the installation port of the receiving chamber is covered by the side wall of the upper insulation shell.

5. The contactor according to claim 1, further comprising a pair of adapter terminals set in the insulation bracket and electrically connected to two connection terminals of the microswitch respectively.

6. The contactor according to claim 5, wherein the insulation bracket is an injection molded part on the pair of adapter terminals, making the insulation bracket and the pair of adapter terminals an integrated piece.

7. The contactor according to claim 5, wherein the adapter terminal has a first tongue located at one end, and the connection terminal of the microswitch has a pair of first spring arms, wherein the first tongue is inserted and clamped between the pair of first spring arms.

8. The contactor according to claim 5, wherein the adapter terminal has a welding piece located at one end, and the connection terminal of the microswitch is needle shaped, the connection terminal of the microswitch passes through the welding piece and is welded to the welding piece.

9. The contactor according to claim 5, further comprising a pair of first lead terminals respectively electrically connected to the other ends of the pair of adapter terminals.

10. The contactor according to claim 9, wherein the adapter terminal has a pair of second spring arms located at its other end, and the first lead terminal has a second tongue located at one end and inserted and clamped between the pair of second spring arms.

11. The contactor according to claim 10, wherein the first lead terminal has a first pin located at its other end adapted for electrical connection to a connector.

12. The contactor according to claim 11, further comprising:
a lower insulation shell assembled together with the upper insulation shell;
a coil skeleton set in the lower insulation shell;
a coil wound around the coil skeleton; and
a pair of second lead terminals respectively electrically connected to the two terminals of the coil, the coil skeleton is an injection molded part onto the pair of first lead terminals and the pair of second lead terminals, such that the coil skeleton, the pair of first lead terminals, and the pair of second lead terminals become one piece.

13. The contactor according to claim 12, wherein:
the second lead terminal has a second pin, and the coil skeleton also has a mating part, in which a slot is formed; and
the first pin and the second pin extend into the slot to be electrically connected to the connector inserted into the slot.

14. The contactor according to claim 11, further comprising:
a lower insulation shell assembled together with the upper insulation shell;
a coil skeleton set in the lower insulation shell;
a coil wound around the coil skeleton;
a pair of second lead terminals electrically connected to the two terminals of the coil respectively; and
a retaining body securing the pair of first lead terminals and installed on the coil skeleton.

15. The contactor according to claim 14, wherein the retaining body is an injection molded part onto the pair of first lead terminals, such that the retaining body and the pair of first lead terminals become an integrated piece.

16. The contactor according to claim 15, wherein the coil skeleton is an injection molded part that is injected onto the pair of second lead terminals, such that the coil skeleton and the pair of second lead terminals become an integrated piece.

17. The contactor according to claim 16, wherein:
a protruding post is formed on the top of the coil skeleton;
an installation hole is formed in the retaining body; and
the protruding post is inserted into the installation hole in an interference fit manner to fix the retaining body on the top of the coil skeleton.

18. The contactor according to claim 16, further comprising a mating part formed with a slot and assembled onto the coil skeleton, the second lead terminal has a second pin, and the first pin and the second pin extend into the slot of the mating part to be electrically connected to the connector inserted into the slot.

19. The contactor according to claim 1, wherein the driving assembly comprises:
an insulation seat;
a drive shaft, located below the insulation seat and fixed to the insulation seat;
a limit bracket located above the insulation seat and fixed to the insulation seat; and
a spring installed in the limit bracket and axially compressed between the movable contact and the insulation seat, the pressing part is formed on the insulation seat and extends into the receiving chamber of the insulation bracket.

20. The contactor according to claim 19, wherein the insulation seat is an injection molded part on the bottom of the limit bracket and the upper end of the drive shaft, such that the insulation seat, the limit bracket, and the drive shaft are integrated into one piece.
